(19) United States
(12) Patent Application Publication
(10) Pub. No.: US 2016/0371122 A1
(43) Pub. Date: Dec. 22, 2016

(54) FILE PROCESSING WORKFLOW MANAGEMENT

(71) Applicant: Hewlett Packard Enterprise Development LP, Houston, TX (US)

(72) Inventor: Rajesh P. Nair, Bangalore Karnataka (IN)

(21) Appl. No.: 15/182,332

(22) Filed: Jun. 14, 2016

(30) Foreign Application Priority Data
Jun. 19, 2015 (IN) 3075/CHE/2015

(51) Int. Cl. G06F 9/50; G06F 9/54

(52) U.S. Cl. CPC G06F 9/505; G06F 9/546; G06F 9/542

(57) ABSTRACT

The present subject matter relates to management of a file processing workflow over processing instances. In an example implementation, a notification message is received from a producer-processing instance of a cluster of processing instances. The notification message comprises a cluster identifier of the cluster associated with the producer-processing instance, and a data resource identifier associated with output data produced by the producer-processing instance in a file processing workflow. Further, the notification message received from the producer-processing instance is forwarded based on the cluster identifier to a message queue for the cluster maintained in the computer. The notification message is transmitted from the message queue for the cluster to a consumer-processing instance of the cluster for processing the output data based on the data resource identifier.

### BACKGROUND

A file processing workflow involves processing of data, for example record sets, over a sequence of processing instances hosted on one or more host nodes. A processing instance may refer to an operating system application process running on a host node. A host node may be a physical machine or a virtual machine. A processing instance, in the sequence, may receive some data and process that data to produce an output data. The output data, from the processing instance, may be provided as an input to a subsequent processing instance in the sequence for further processing.

### BRIEF DESCRIPTION OF DRAWINGS

The following detailed description references the drawings, wherein:

FIG. 1 illustrates a system environment having a workflow management system, according to an example implementation of the present subject matter;

FIG. 2 illustrates a multi-tier processing instance environment having the workflow management system, according to an example implementation of the present subject matter;

FIG. 3 illustrates a method for managing a file processing workflow over multiple processing instances, according to an example implementation of the present subject matter;

FIG. 4 illustrates a method for scaling up processing instances for managing a file processing workflow, according to an example implementation of the present subject matter;

FIG. 5 illustrates a method for scaling processing instances for managing a file processing workflow, according to an example implementation of the present subject matter; and

FIG. 6 illustrates a system environment, according to an example implementation of the present subject matter.

### DETAILED DESCRIPTION

The present subject matter describes management of file processing workflows. Data processing in a file processing workflow may be performed in a multi-tier processing instance environment hosted on one or more host nodes. In such an environment, each tier may include one or more processing instances that can handle data processing. The processing instances at a tier may be copies of each other, i.e., have the same internal processing logic configuration. In the multi-tier processing instance environment, the processing instances at each tier may receive an input data, process the input data, and produce an output data. The output data may then be provided as an input to the processing instances at the next tier for processing.

The processing instances in a multi-tier processing instance environment generally are hard-wired with each other, and a defined number of processing instances at each tier are statically configured at the time of designing of the multi-tier processing instance environment. The processing instances are statically configured with a predefined set of rules to receive data from the processing instances of a previous tier, process the data, and produce output data for the processing instances of a subsequent tier. With the static configuration, the processing instances at each tier can handle a predefined workload during the file processing workflow. Thus, if the workload increases at a tier then the processing instances at the tier may become a bottleneck, and if the workload decreases at a tier then the processing instances at the tier may be under-utilized. The bottleneck may slow down the workflow and adversely affect the quality of service of the workflow. The under-utilization of the processing instances may result in wastage of resources and make the tier and the multi-tier processing instance environment inefficient. Thus, the workload may have to be balanced during the file processing workflow.

With the static configuration in the multi-tier processing instance environment, processing instances cannot be scaled up or scaled down at any tier, at run-time. The operation of the workflow may have to be disrupted in order to scale-up or scale-down the processing instances at any tier. Herein, the scale-up refers to a process of adding one or more processing instances at any tier, and the scale-down refers to a process of removing one or more processing instances from any tier. Without scaling up or scaling down of the processing instances at the tiers, the workload balancing for the file processing workflow cannot be performed at run-time.

The present subject matter describes methods and systems for management of file processing workflows in a multi-tier processing instance environment. The methods and the systems of the present subject matter enable scaling up and scaling down of processing instances at any of the tiers at run-time, without disrupting the operation of the file processing workflow.

In accordance with an example implementation of the present subject matter, the processing instances at a tier that produce output data for a next tier and the processing instances at the next tier that consume the output data from the previous tier are grouped in a cluster. A processing instance that produces an output data for the next tier may be referred to as a producer-processing instance. A processing instance that consumes the output data from the previous tier may be referred to as a consumer-processing instance. Thus, for example, in a three-tier processing instance environment, the processing instances at tier 1 are the producer-processing instances and the processing instances at tier 2 are the consumer-processing instances grouped in one cluster. Similarly, the processing instances at tier 2 are the producer-processing instances and the processing instances at tier 3 are the consumer-processing instances grouped in another cluster.

In an example implementation, a computing system maintains a message queue for each cluster of processing instances. The message queue for a cluster holds messages based on which work, or jobs, in the file processing workflow can be passed from the producer-processing instances of the cluster to the consumer-processing instances of the cluster. The computing system may include, but is not restricted to, a server, a mainframe computer, a desktop computer, a laptop computer, and the like.

For passing a job from the producer-processing instance to the consumer-processing instance of the cluster, the producer-processing instance generates a notification message upon producing an output data and sends the notification message to the computing system. The notification message received by the computing system includes a cluster identifier (ID) of the cluster associated with the producer-processing instance, and includes a data resource identifier (ID) associated with the output data produced by the producer-processing instance. After receiving the notification message, the computing system forwards the notification message to the message queue for the cluster based on the cluster ID. The computing system then transmits the notification message from the message queue for the cluster to the consumer-processing instance of the cluster for processing the output data. The consumer-processing instance, upon receiving the notification message, may determine the data resource identifier from the notification message and access the output data from the producer-processing instance based on the data resource identifier. The procedure of passing a job may be followed by the producer-processing instances and the consumer-processing instances of each cluster in the multi-tier processing instance environment.

By grouping the processing instances at different tiers into clusters and orchestrating the file processing workflow using the computing system based on the message queues and the notification messages for the clusters, the static configuration between the processing instances can be eliminated. Without having the static configuration, the processing instances at any of the tiers can be dynamically scaled up or scaled down at run-time, without disrupting the operation of the file processing workflow. The scaling up allows adding one or more new processing instances at a tier so that the workload can be shared in case of a bottleneck at the tier. The scaling down allows removal of one or more existing processing instances at a tier so that wastage of resources can be substantially reduced or eliminated. Further, the scaling up of the processing instances at a tier also enables building a level of redundancy of processing instances for achieving high availability. With a level of redundancy of processing instances at a tier, if a processing instance fails or turns faulty, the other processing instance(s) at the tier can handle the data processing without disrupting the file processing workflow.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

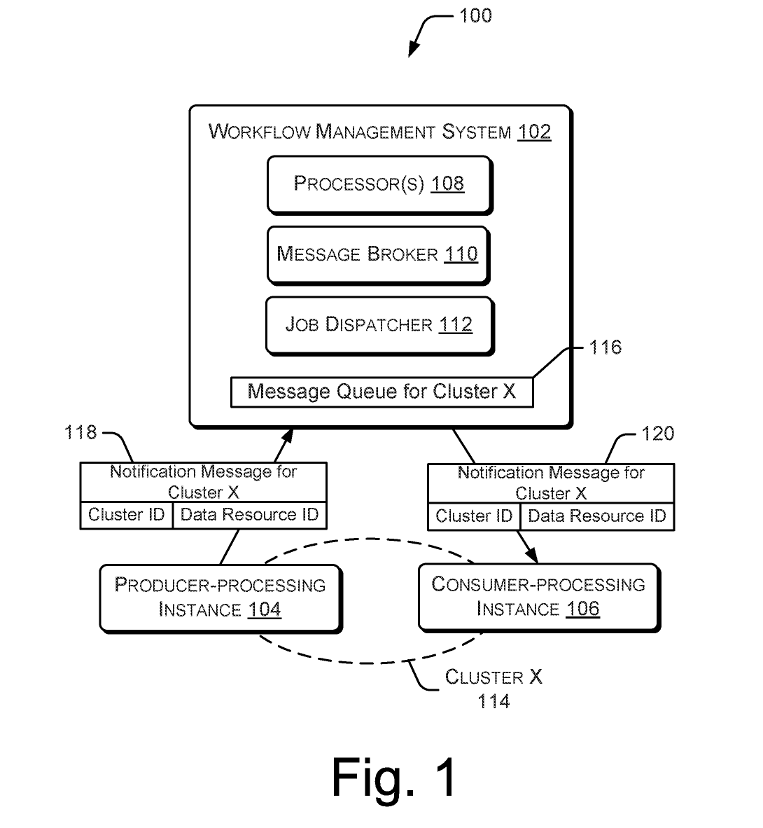

FIG. 1 illustrates a system environment 100 having a workflow management system 102, according to an example implementation of the present subject matter. The workflow management system 102 may be implemented in various ways. For example, the workflow management system 102 may be a special purpose computer, a server, a mainframe computer, and/or any other type of computing device. The workflow management system 102 enables management of a file processing workflow over processing instances, in accordance with the present subject matter.

As shown in FIG. 1, the system environment 100 includes a producer-processing instance 104 and a consumer-processing instance 106 involved in a file processing workflow. The producer-processing instance 104 and the consumer-processing instance 106 belong to a sequence of processing instances at different tiers in a multi-tier processing instance environment. The multi-tier processing instance environment can be hosted on one or more host nodes. In an example, the producer-processing instance 104 and the consumer-processing instance 106 are at adjacent tiers. The producer-processing instance 104 processes some data in the file processing workflow and produces an output data, and the consumer-processing instance 106 consumes the output data of the producer-processing instance 104 for further processing. Although one producer-processing instance 104 and one consumer-processing instance 106 are shown in FIG. 1; however, the system environment 100 may include more than one producer-processing instance and more than one consumer-processing instance at the different tiers. Further, although the system environment 100 shows processing instances at two tiers; however, the system environment 100 may include processing instances at more than two tiers.

As shown in FIG. 1, the workflow management system 102 includes processor(s) 108. The processor(s) 108 may be implemented as microprocessors, microcomputers, microcontrollers, digital signal processors, central processing units, state machines, logic circuitries, and/or any devices that manipulate signals based on operational instructions. Among other capabilities, the processor(s) 108 may fetch and execute computer-readable instructions stored in a memory coupled to the processor(s) 108 of the workflow management system 102. The memory can be internal or external to the workflow management system 102. The memory may include any non-transitory computer-readable storage medium including, for example, volatile memory (e.g., RAM), and/or non-volatile memory (e.g., EPROM, flash memory, NVRAM, memristor, etc.). The functions of the various elements shown in FIG. 1, including any functional blocks labeled as “processor(s)”, may be provided through the use of dedicated hardware as well as hardware capable of executing computer-readable instructions.

As shown in FIG. 1, the workflow management system 102 includes a message broker 110 and a job dispatcher 112. The message broker 110 and the job dispatcher 112, amongst other things, include routines, programs, objects, components, data structures, and the like, which perform particular tasks or implement particular abstract data types. The message broker 110 and the job dispatcher 112 may be coupled to, and executed by, the processor(s) 108 to perform various functions for the purpose of managing a file processing workflow over the producer-processing instance 104 and the consumer-processing instance 106, in accordance with the present subject matter.

The description hereinafter describes, in detail, the procedure of managing a file processing workflow over the producer-processing instance 104 and the consumer-processing instance 106 using the workflow management system 102, in accordance with an example implementation.

In an example implementation, the message broker 110 registers the producer-processing instance 104 and the consumer-processing instance 106 in a cluster of processing instances. The cluster may be a virtual cluster. In registering the producer-processing instance 104 and the consumer-processing instance 106, a cluster ID may be created and the information, for example, IDs of the producer-processing instance 104 and the consumer-processing instance 106 may be associated with the cluster ID and stored in the memory of the workflow management system 102. In an example, the cluster ID may be a cluster name, and the information of the producer-processing instance 104 and the consumer-processing instance 106 may be processing instance names. In an example, as shown in FIG. 1, the cluster ID is “Cluster X” 114, and IDs of the producer-processing instance 104 and the consumer-processing instance 106 are associated with Cluster X and stored in the memory of the workflow management system 102. Table 1 shows an example data that may be stored in the workflow management system 102 upon registering the producer-processing instance 104 and the consumer-processing instance 106 in Cluster X by the message broker 110.

TABLE 1
Cluster X

| Producer-processing instances | Consumer-processing instances |
|---|---|
| ID of producer-processing | ID of consumer-processing |
| instance 104 | instance 106 |

Based on the registration of the producer-processing instance 104 and consumer-processing instance 106 in the cluster, the message broker 110 creates and maintains a message queue for the cluster. The message queue for the cluster holds messages associated with the cluster based on which work or jobs can be passed from the producer-processing instance 104 to the consumer-processing instance 106. As shown in FIG. 1, a message queue 116 for Cluster X is maintained in the workflow management system 102. In an example, the message queue 116 may be stored and maintained in the memory of workflow management system 102.

During the file processing workflow, the producer-processing instance 104 may receive data from an external processing resource or from a previous tier of the system environment 100, as the case may be. The producer-processing instance 104 processes the received data to produce an output data. Upon producing the output data, the producer-processing instance 104 generates a notification message for the cluster and sends the notification message to the workflow management system 102. The notification message comprises a cluster ID of the cluster associated with the producer-processing instance 104 and a data resource ID associated with the output data produced by the producer-processing instance 104. The cluster ID may be the cluster name of the cluster associated with the producer-processing instance 104 and the consumer-processing instance 106, and the data resource ID may be a uniform resource locator (URL) associated with the output data. An example notification message 118 for Cluster X sent from the producer-processing instance 104 to the workflow management system 102 is shown in FIG. 1.

The message broker 110 receives the notification message from the producer-processing instance 104 and forwards the notification message to the message queue for the cluster. In an example, the notification message 118 may be received in a central message queue maintained in the workflow management system 102. The message broker 110 may determine the cluster ID from the notification message 118, and accordingly forward the notification message 118 to the message queue 116 for Cluster X.

After the notification message is forwarded to the message queue for the cluster, the job dispatcher 112 transmits the notification message from the message queue to the consumer-processing instance 106 of the cluster. An example notification message 120 for Cluster X sent from the message queue for Cluster X to the consumer-processing instance 106 is shown in FIG. 1. Upon receiving the notification message 120, the consumer-processing instance 106 may determine the data resource ID from the notification message 120, and access the output data of the producer-processing instance 104 based on the data resource ID. For accessing the output data based on the data resource ID, the consumer-processing instance 106 may dynamically, i.e., in real-time, establish a connection with the producer-processing instance 104. The consumer-processing instance 106 may access the output data through the dynamically established connection and process that data to produce a further output data for a next tier of the system environment 100 or for an external processing resource.

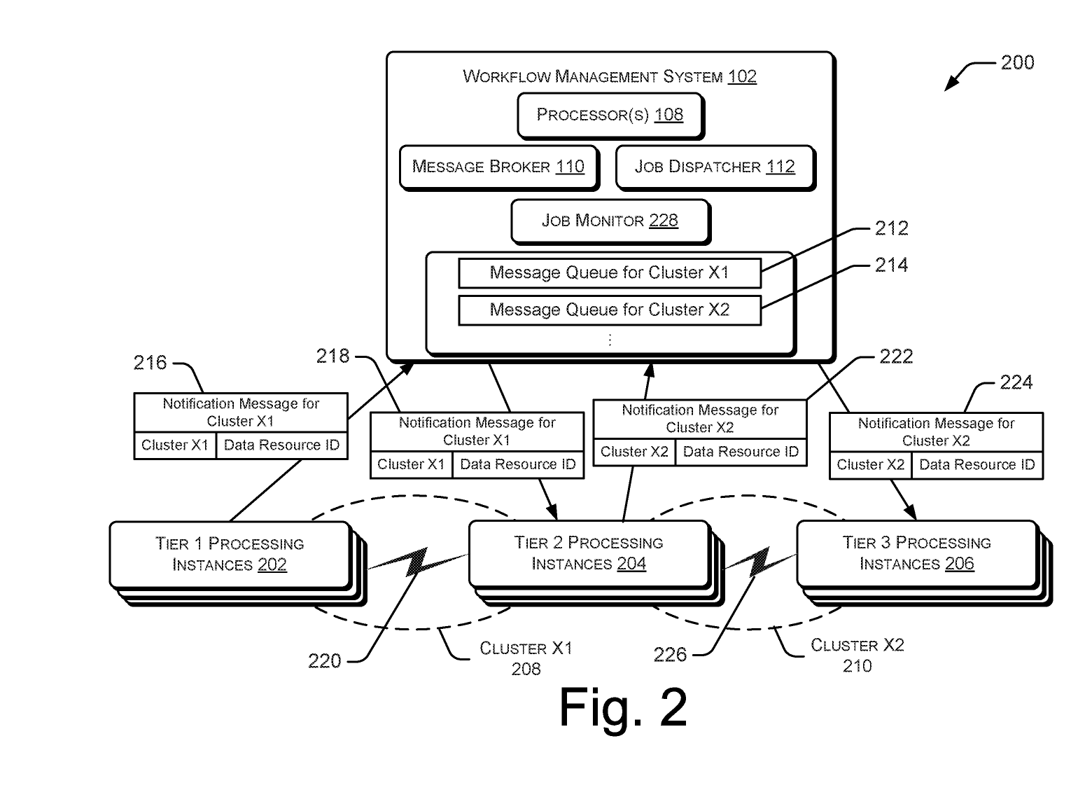

FIG. 2 illustrates a multi-tier processing instance environment 200 having the workflow management system 102, according to an example implementation of the present subject matter. The example implementation in FIG. 2 shows a three tier environment; however, the multi-tier processing instance environment 200 can include more than three tiers.

As shown, the multi-tier processing instance environment 200 includes tier 1 processing instances 202, tier 2 processing instances 204, and tier 3 processing instances 206 which are involved in a file processing workflow. The tier 1 processing instances 202 are producer-processing instances that produce an output data, and the tier 2 processing instances 204 are consumer-processing instances that consume the output data of the tier 1 processing instances 202. Similarly, the tier 2 processing instances 204 are producer-processing instances that produce another output data, and the tier 3 processing instances 206 are consumer-processing instances that consume the output data of the tier 2 processing instances 204. Thus, the tier 1 processing instances 202 are registered as the producer-processing instances and the tier 2 processing instances 204 are registered as the consumer-processing instances of a cluster, for example, Cluster X1 208. Similarly, the tier 2 processing instances 204 are registered as the producer-processing instances and the tier 3 processing instances 206 are registered as the consumer-processing instances of a cluster, for example, Cluster X2 210. The terms “Cluster X1” and “Cluster X2” may be the cluster IDs associated with the two clusters.

For registering the tier 1 processing instances 202, the tier 2 processing instances 204, and the tier 3 processing instances 206, the message broker 110 may create the cluster IDs Cluster X1 and Cluster X2 and store the data as shown in Table 2 and Table 3 in the memory of the workflow management system 102.

TABLE 2
Cluster X1

| Producer-processing instances | Consumer-processing instances |
|---|---|
| IDs of tier 1 processing | IDs of tier 2 processing |
| instances 202 | instances 204 |

TABLE 3
Cluster X2

| Producer-processing instances | Consumer-processing instances |
|---|---|
| IDs of tier 2 processing | IDs of tier 3 processing |
| instances 204 | instances 206 |

Based on the registration of processing instances in Cluster X1 and Cluster X2, the message broker 110 creates and maintains a message queue 212 for Cluster X1 and a message queue 214 for Cluster X2. In an example, the message queues 212 and 214 may be stored and maintained in the memory of workflow management system 102.

In the file processing workflow, each of the tier 1 processing instances 202 produces an output data, and accordingly generates a notification message 216 for Cluster X1 and sends the notification message 216 to the workflow management system 102. The notification message 216 comprises the cluster ID of Cluster X1 and a data resource ID associated with the output data produced by the respective tier 1 processing instance 202. The message broker 110 receives the notification message 216 and forwards the notification message 216 to the message queue 212 for Cluster X1. In an example, the notification messages received from the tier 1 processing instances 202 are sequentially forwarded to the message queue 212 for Cluster X1.

After this, the job dispatcher 112 transmits a notification message 218 from the message queue 212 to one of the tier 2 processing instances 204. In an example, the job dispatcher 112 may transmit the notification message 218 to a tier 2 processing instance 204 based on a job request message received from that tier 2 processing instance 204. According to an example implementation, a consumer-processing instance may send a job request message to the workflow management system 102 based on the availability and the processing capacity of the consumer-processing instance. Thus, each consumer-processing instance can pull a processing load associated with the file processing workflow, instead the processing load being pushed to the consumer-processing instance. This helps the consumer-processing instance to process the data efficiently without over burdening itself. After receiving the notification message 218, the tier 2 processing instance 204 determines the data resource ID from the notification message 218, and accesses the output data of the tier 1 processing instance 202 based on the data resource ID. The tier 2 processing instance 204 dynamically establishes a connection 220 with the tier 1 processing instance 202 for accessing the output data.

Further, the tier 2 processing instance 204 accesses the output data and process that data to produce a further output data. The tier 2 processing instance 204 accordingly generates a notification message 222 for Cluster X2 and sends the notification message 222 to the workflow management system 102. The notification message 222 comprises the cluster ID of Cluster X2 and a data resource ID associated with the output data produced by the tier 2 processing instance 204. The message broker 110 receives the notification message 222 and forwards the notification message 222 to the message queue 214 for Cluster X2. The notification messages received from the tier 2 processing instances 204 are sequentially forwarded to the message queue 214 for Cluster X2.

After this, the job dispatcher 112 transmits a notification message 224 from the message queue 214 to one of the tier 3 processing instances 206. In an example, the job dispatcher 112 may transmit the notification message 224 to a tier 3 processing instance 206 based on a job request message received from the tier 3 processing instance 206. After receiving the notification message 224, the tier 3 processing instance 206 determines the data resource ID from the notification message 224, and accesses the output data of the tier 2 processing instance 204 based on the data resource ID. The tier 3 processing instance 206 dynamically establishes a connection 226 with the tier 2 processing instance 204 for accessing the output data. The tier 3 processing instance 206 may access the output data and process that data to produce a further output data for a next tier of the multi-tier processing instance environment 200 or for an external processing resource.

According to an example implementation, the notification messages are held in the message queue for the cluster until the notification messages are pulled by the consumer-processing instances of the cluster. Each notification message in a message queue for a cluster may be indicative of or represent a processing job for a consumer-processing instance associated with the cluster. As shown in FIG. 2, the workflow management system 102 includes a job monitor 228 for determining various operational parameters for each job and for each cluster and monitoring key-performance indicators associated with the file processing workflow based on which workload balancing can be performed. The job monitor 228, amongst other things, includes routines, programs, objects, components, data structures, and the like, which perform particular tasks or implement particular abstract data types. The job monitor 228 may be coupled to, and executed by, the processor(s) 108 to perform various functions for the purpose of determining the operational parameters for each job and for each cluster and monitoring key-performance indicators associated with the file processing workflow, in accordance with the present subject matter. The operational parameters for a job for a cluster may include, but are not restricted to, the cluster ID, a job ID, a job state, and a job state transition time. The key-performance indicators may include, but are not restricted to, a number of pending jobs, a job production throughput, and a job consumption throughput. The details of the operational parameters and the key-performance indicators are provided later in the description.

In an example implementation, the job monitor 228 may scan the message queue for a cluster and determine a number of pending jobs for the cluster based on a number of notification messages pending in the message queue for the cluster. High number of pending jobs for a cluster may be indicative of a bottleneck in the file processing workflow. Thus, when the number of pending jobs exceeds a pending jobs threshold value, the job monitor 228 may generate an alarm message. The pending jobs threshold value can be a user defined value. The alarm message can be provided to a workload management system (not shown). Based on the alarm message in the workload management system, one or more new consumer-processing instances can be created and deployed for the cluster, and accordingly a response message may be sent to the workflow management system 102. The response message may include information of the one or more new consumer-processing instances. The consumer-processing instances can be created and deployed either manually by a user or automatically by the workload management system. A new consumer-processing instance can be a copy of an existing consumer-processing instance of the cluster, having the same run-time environment. In an example, the new consumer-processing instance can be a copy of an existing consumer-processing instance with the same internal processing logic configuration as that of the existing consumer-processing instance. Based on the response message received by the workflow management system 102, the message broker 110 may register, in real-time, the one or more consumer-processing instances for the cluster. The registration of one or more new consumer-processing instances amounts to scaling up of the processing instances for balancing the workload. The newly registered consumer-processing instances for the cluster can thus start sending job request messages and receive the notification messages from the message queue for the cluster. Thus, the number of pending jobs and the bottleneck of the file processing workflow can be reduced.

In an example implementation, the job monitor 228 may determine a job production throughput for the cluster based on a rate at which the notification messages are forwarded in the message queue for the cluster. Similarly, the job monitor 228 may determine a job consumption throughput for the cluster based on a rate at which the notification messages are consumed from the message queue for the cluster. If the rate of forwarding the notification message in the message queue is more than the rate of consuming the notification message from the message queue, then the job production throughput is more than the job consumption throughput, which may be indicative of a bottleneck in the file processing workflow. Thus, when the job production throughput exceeds the job consumption throughput, for example, by a first threshold rate value, the job monitor 228 may generate an alarm message that can be provided to the workload management system. The first threshold rate value can be a user defined value. In an example, the first threshold rate value may be 10 notification messages per second. Based on this alarm message in the workload management system, one or more new consumer-processing instances can be created and deployed for the cluster, and accordingly a response message can be sent to the workflow management system 102. The consumer-processing instances can be created and deployed either manually by a user or automatically by the workload management system. Based on the response message received by the workflow management system 102, the message broker 110 may register, in real-time, the one or more consumer-processing instances for the cluster. Registration of one or more new consumer-processing instances amounts to scaling up of the processing instances for balancing the workload. The newly registered consumer-processing instances for the cluster can thus start sending job request messages and receive the notification messages from the message queue for the cluster. Thus, the job consumption throughput can be increased and the bottleneck in the file processing workflow can be reduced.

Similarly, if the rate of consuming the notification message from the message queue is more than the rate of forwarding the notification message in the message queue, then the job consumption throughput is more than the job production throughput, which may be indicative of under-utilization of consumer-processing instances for the cluster. Thus, when the job consumption throughput exceeds the job production throughput, for example, by a second threshold rate value, the job monitor 228 may generate an alarm message that can be provided to the workload management system. The second threshold rate value can also be a user defined value. In an example, the second threshold rate value may be 10 notification messages per second. Based on this alarm message in the workload management system, one or more existing consumer-processing instances for the cluster can be removed either manually by a user or automatically by the workload management system. Accordingly a response message can be sent to the workflow management system 102, where the response message may include information of the existing consumer-processing instances that are to be removed. Based on the response message, the message broker 110 may deregister, in real-time, the one or more existing consumer-processing instances for the cluster. In an example implementation, an existing consumer-processing instance can be deregistered based on the processing capacity of the consumer-processing instance. The consumer-processing instance with the least processing capacity may be selected for deregistration. Deregistration of one or more existing consumer-processing instances amounts to scaling down of the processing instances for balancing the workload. By deregistering one or more existing consumer-processing instances for the cluster, the wastage of resources in the multi-tier processing instance environment 200 can be reduced.

Further, in an example implementation, the job monitor 228 may determine one or more operational parameters for each job and for each cluster during the file processing workflow. The operational parameters may refer to meta-data associated with the job and the cluster. As mentioned earlier, the operational parameters for a cluster may include, but are not restricted to, the cluster ID, a job ID, a job state, and a job state transition time. The cluster ID identifies the cluster and the corresponding message queue in the workflow management system 102, the job ID identifies a job or a notification message in the message queue, the job state identifies the state of processing job, and the job state transition time that indicates the time at which the job state changed from one state to another state. The job state may be one of predefined job states. The predefined job states may include: “Available” indicating that the job or the notification message is pending and available for consumption by a consumer-processing instance of the cluster; “Assigned” indicating that the job is assigned to a particular consumer-processing instance; “Data Transferred” indicating that the data associated with the job is transferred to the consumer-processing instance; and “Completed” indicating that the job is completed by the consumer-processing instance.

In an example implementation, the job monitor 228 may determine the cluster ID based on the notification message received from the producer-processing instance for the cluster. In an example, the producer-processing instance for the cluster may also include the job ID in the notification message to be sent to the workflow management system 102. The job monitor 228 may determine the job ID from the notification message received from the producer-processing instance. Further, for each notification message in the message queue, the message broker 110 may set and change the job state and the job state transition time, and accordingly the job monitor 228 may determine the job state and the job state transition time. When the notification message is forwarded to the message queue, the job state may be set as “Available”. The job state may be changed according to the processing of the job associated with the notification message.

Further, in an example implementation, the job monitor 228 receives meta-data associated with the output data from the producer-processing instance of a cluster. The producer-processing instance of the cluster may include the meta-data associated with the output data in the notification message sent to the workflow management system 102. The job monitor 228 may obtain the meta-data associated with output data from the notification message. In an example, the meta-data associated with the output data may include, but are not restricted to, an ID associated with a parent output data of the output data, a number of records in the output data, a size of the output data, a timestamp at which the output data is created, an ID associated with the producer-processing instance that produced the output data, and a checksum value of the output data. The job monitor 228 may receive the meta-data associated with the output data from each producer-processing instance for each cluster. In an example implementation, the job monitor 228 provides the meta-data associated with the output data to an audit manager (not shown). Using the meta-data, the audit manager can construct relationships between the output data for the file processing workflow for auditing the file processing workflow.

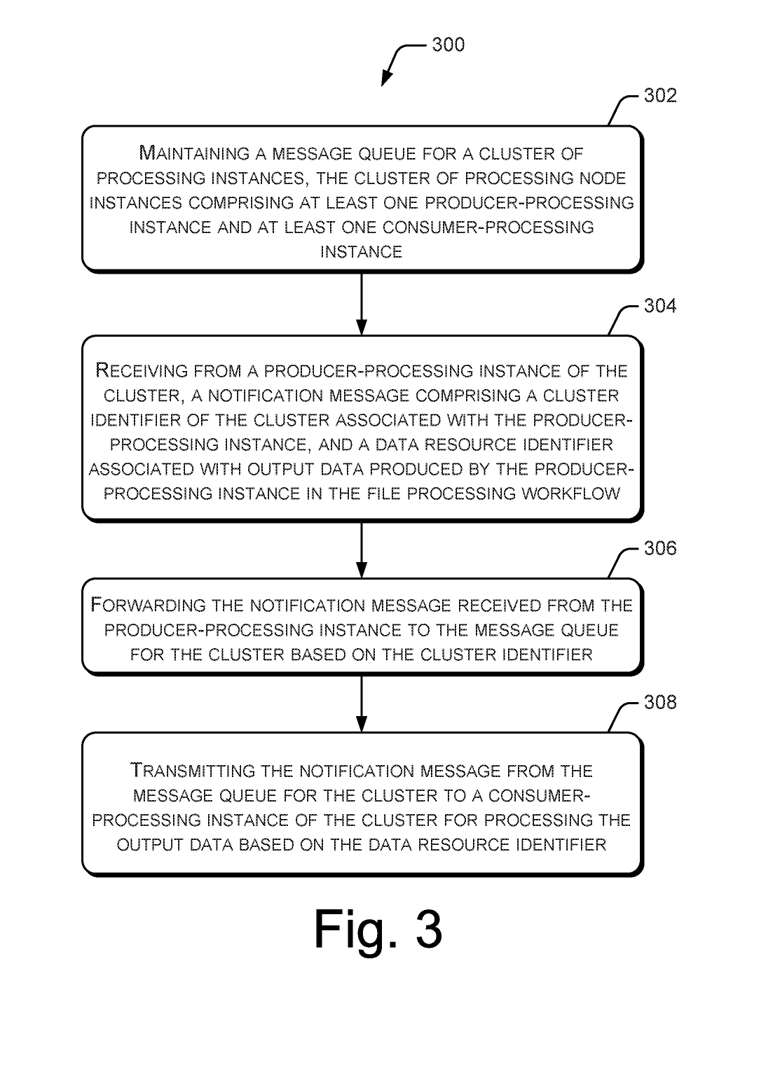

FIG. 3 illustrates a method 300 for managing a file processing workflow over multiple processing instances, according to an example implementation of the present subject matter. The order in which the method 300 is described is not intended to be construed as a limitation, and any number of the described method blocks can be combined in any order to implement the method 300. Furthermore, the method 300 can be implemented by processor(s) or computing device(s) through any suitable hardware, a non-transitory machine readable medium, or combination thereof. Further, although the method 300 is described in context of the aforementioned workflow management system 102, other suitable computing devices or systems may be used for execution of the method 300. It may be understood that processes involved in the method 300 can be executed based on instructions stored in a non-transitory computer readable medium, as will be readily understood. The non-transitory computer readable medium may include, for example, digital memories, magnetic storage media, such as a magnetic disks and magnetic tapes, hard drives, or optically readable digital data storage media.

Referring to FIG. 3, at block 302, a message queue for a cluster of processing instances is maintained, where the cluster of processing instances includes at least one producer-processing instance and at least one consumer-processing instance. The message queue for the cluster may be created and maintained by the workflow management system 102 based on the registration of at least one producer-processing instance and at least one consumer-processing instance in the cluster. The cluster is one of a plurality of clusters of processing instances in a multi-tier processing instance environment 200, and the at least one producer-processing instance and the at least one consumer-processing instance of the cluster are at different tiers of the multi-tier processing instance environment 200.

At block 304, a notification message is received from a producer-processing instance of the cluster. The notification message includes a cluster ID of the cluster associated with the producer-processing instance, and a data resource ID associated with output data produced by the producer-processing instance in the file processing workflow. The notification message may be generated by the producer-processing instance based on the output data and sent to the workflow management system 102. In an example, the cluster ID may be the cluster name, and the data resource ID may be a URL for the output data.

At block 306, the notification message received from the producer-processing instance is forwarded to the message queue for the cluster based on the cluster identifier. The workflow management system 102 may determine the cluster ID from the notification message, and accordingly forward the notification message to the message queue for the cluster.

Further, at block 308, the notification message is transmitted from the message queue for the cluster to a consumer-processing instance of the cluster for processing the output data based on the data resource identifier. The workflow management system 102 may receive a job request message from the consumer-processing instance of the cluster, and accordingly transmit the notification message from the message queue to the consumer-processing instance.

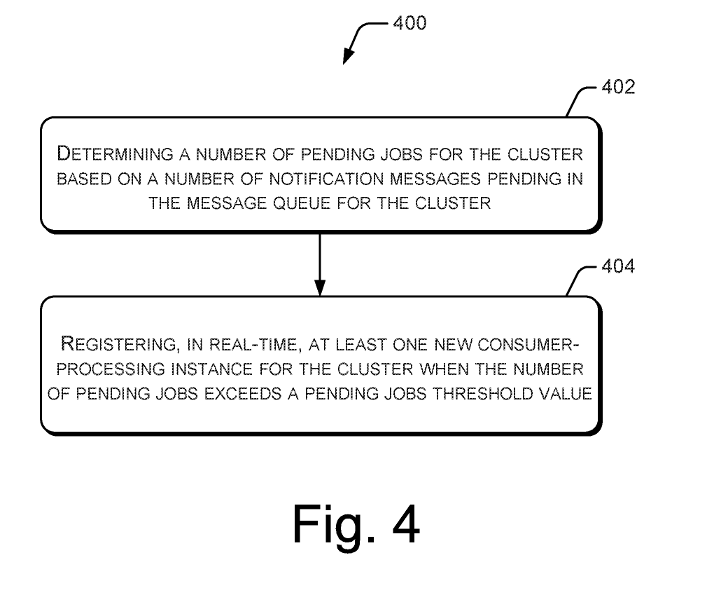

FIG. 4 illustrates a method 400 for scaling up processing instances for managing a file processing workflow, according to an example implementation of the present subject matter. Any number of described method blocks can be combined in any order to implement the method 400. Furthermore, the method 400 can be implemented by processor(s) or computing device(s) through any suitable hardware, a non-transitory machine readable medium, or combination thereof. Further, although the method 400 is described in context of the aforementioned workflow management system 102, other suitable computing devices or systems may be used for execution of the method 400. It may be understood that processes involved in the method 400 can be executed based on instructions stored in a non-transitory computer readable medium, as will be readily understood. The non-transitory computer readable medium may include, for example, digital memories, magnetic storage media, such as a magnetic disks and magnetic tapes, hard drives, or optically readable digital data storage media.

Referring to FIG. 4, at block 402, a number of pending jobs for the cluster is determined based on a number of notification messages pending in the message queue for the cluster. The workflow management system 102 may scan the message queue for the cluster and determine the number of pending jobs. At block 404, at least one new consumer-processing instance is registered, in real-time, for the cluster when the number of pending jobs exceeds a pending jobs threshold value. When the number of pending jobs is more than the pending jobs threshold value, the workflow management system 102 may generate an alarm message. Based on the alarm message, at least one new consumer-processing instance can be created and added either manually or automatically using an automated system. The workflow management system 102 may register the at least one new consumer-processing instance in real-time. By registering the at least one consumer-processing instance, the number of the consumer-processing instances of the cluster and thus the capacity to process data can be scaled up in real-time, without disrupting the file processing workflow.

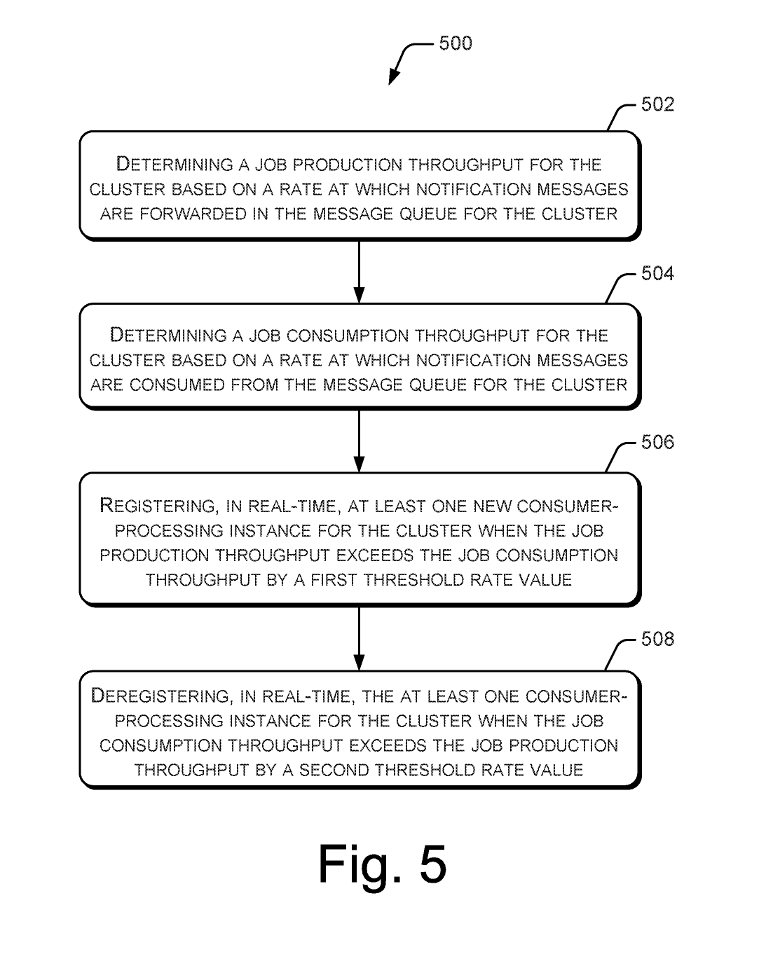

FIG. 5 illustrates a method 500 for scaling processing instances for managing a file processing workflow, according to an example implementation of the present subject matter. The order in which the method 500 is described is not intended to be construed as a limitation, and any number of the described method blocks can be combined in any order to implement the method 500. Furthermore, the method 500 can be implemented by processor(s) or computing device(s) through any suitable hardware, a non-transitory machine readable medium, or combination thereof. Further, although the method 500 is described in context of the aforementioned workflow management system 102, other suitable computing devices or systems may be used for execution of the method 500. It may be understood that processes involved in the method 500 can be executed based on instructions stored in a non-transitory computer readable medium, as will be readily understood. The non-transitory computer readable medium may include, for example, digital memories, magnetic storage media, such as a magnetic disks and magnetic tapes, hard drives, or optically readable digital data storage media.

Referring to FIG. 5, at block 502, a job production throughput for the cluster is determined based on a rate at which notification messages are forwarded in the message queue for the cluster. At block 504, a job consumption throughput for the cluster is determined based on a rate at which notification messages are consumed from the message queue for the cluster. The job production throughput and the job consumption throughput for the cluster may be determined by the workflow management system 102 based on the forwarding and the consuming of the notification messages in the message queue for the cluster.

At block 506, at least one new consumer-processing instance for the cluster is registered, in real-time, when the job production throughput exceeds the job consumption throughput by a first threshold rate value. When the job production throughput is more than the job consumption throughput by the first threshold rate value, the workflow management system 102 may generate an alarm message. Based on the alarm message, at least one new consumer-processing instance can be created and added either manually or automatically using an automated system. The workflow management system 102 may register the at least one new consumer-processing instance in real-time. By registering the at least one new consumer-processing instance, the number of the consumer-processing instances of the cluster and thus the capacity to process data can be scaled up in real-time, without disrupting the file processing workflow.

At block 508, the at least one consumer-processing instance for the cluster is deregistered, in real-time, when the job consumption throughput exceeds the job production throughput by a second threshold rate value. When the job consumption throughput is more than the job production throughput by the second threshold rate value, the workflow management system 102 may generate an alarm message. Based on the alarm message, at least one existing consumer-processing instance for the cluster can be removed either manually or automatically using an automated system. The workflow management system 102 may deregister the at least one existing consumer-processing instance in real-time. By deregistering the at least one existing consumer-processing instance, the number of the consumer-processing instances of the cluster can be scaled down in real-time, without disrupting the file processing workflow.

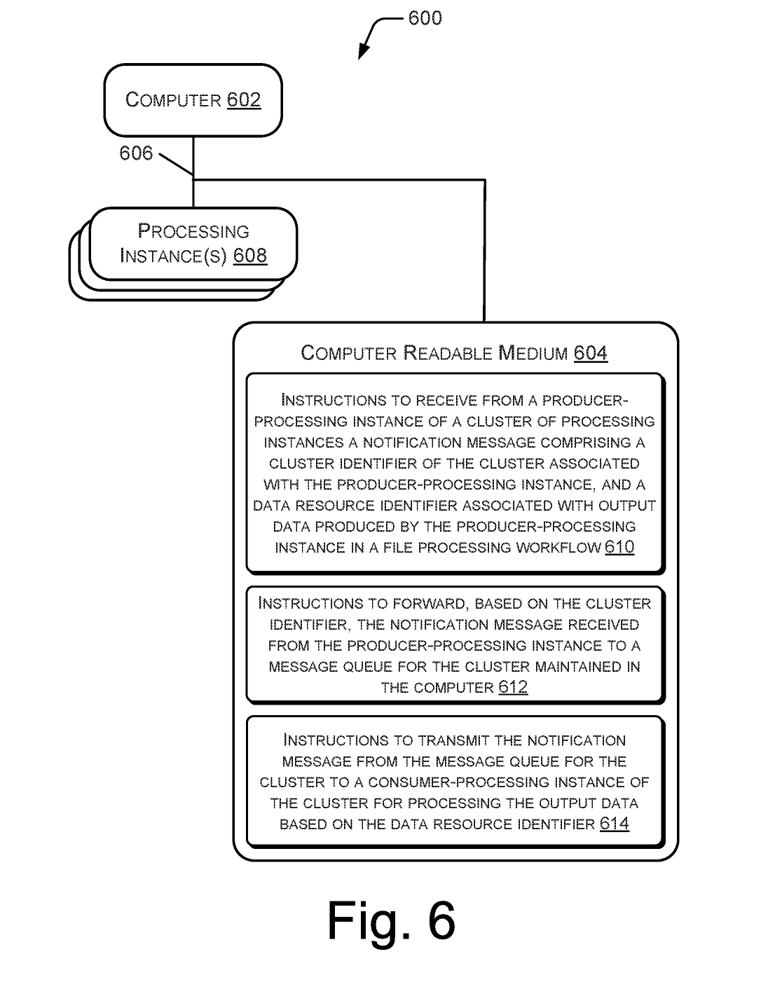

FIG. 6 illustrates a system environment 600, according to an example implementation of the present subject matter. In an example implementation, the system environment 600 includes a computer 602 communicatively coupled to a non-transitory computer readable medium 604 through a communication link 606. The computer 602 has one or more processing resources for fetching and executing computer-readable instructions from the non-transitory computer readable medium 604.

The computer 602 and the non-transitory computer readable medium 604 are also communicatively coupled to processing instance(s) 608. The processing instance(s) 608 can include producer-processing instances and consumer-processing instances associated with one or more clusters, as described earlier, for processing data in a file processing workflow.

The non-transitory computer readable medium 604 can be, for example, an internal memory device or an external memory device. In an example implementation, the communication link 606 may be a direct communication link, such as any memory read/write interface. In another example implementation, the communication link 606 may be an indirect communication link, such as a network interface. In such a case, the computer 602 can access the non-transitory computer readable medium 604 through a network (not shown). The network may be a single network or a combination of multiple networks and may use a variety of different communication protocols.

In an example implementation, the non-transitory computer readable medium 604 includes a set of computer readable instructions for managing a file processing workflow over processing instances. The set of computer readable instructions can be accessed by the computer 602 through the communication link 606 and subsequently executed to perform acts for managing the file processing workflow.

Referring to FIG. 6, in an example, the non-transitory computer readable medium 604 includes instructions 610 that cause the computer 602 to receive from a producer-processing instance of a cluster of processing instances a notification message, where the notification message includes a cluster identifier of the cluster associated with the producer-processing instance, and a data resource identifier associated with output data produced by the producer-processing instance in the file processing workflow. The non-transitory computer readable medium 604 includes instructions 612 that cause the computer 602 to forward, based on the cluster identifier, the notification message received from the producer-processing instance to a message queue for the cluster maintained in the computer. The non-transitory computer readable medium 604 includes instructions 614 that cause the computer 602 to transmit the notification message from the message queue for the cluster to a consumer-processing instance of the cluster for processing the output data based on the data resource identifier.

In an example implementation, the non-transitory computer readable medium 604 may further include instructions that cause the computer 602 to: determine a number of pending jobs for the cluster based on a number of notification messages pending in the message queue for the cluster; and register, with the computer 602, in real-time, at least one new consumer-processing instance for the cluster when the number of pending jobs exceeds a pending jobs threshold value.

In an example implementation, the non-transitory computer readable medium 604 may further include instructions that cause the computer 602 to determine a job production throughput for the cluster based on a rate at which notification messages are forwarded in the message queue for the cluster; and determine a job consumption throughput for the cluster based on a rate at which notification messages are consumed from the message queue for the cluster. In an example implementation, the non-transitory computer readable medium 604 may further include instructions that cause the computer 602 to register, with the computer 602, in real-time, at least one new consumer-processing instance for the cluster when the job production throughput exceeds the job consumption throughput by a first threshold rate value. In an example implementation, the non-transitory computer readable medium 604 may further include instructions that cause the computer 602 to deregister, from the computer 602, in real-time, the at least one consumer-processing instance for the cluster when the job consumption throughput exceeds the job production throughput by a second threshold rate value.

Although implementations for client communication in multi-tenant data center networks have been described in language specific to structural features and/or methods, it is to be understood that the present subject matter is not limited to the specific features or methods described. Rather, the specific features and methods are disclosed and explained as example implementations for client communication in multi-tenant data center networks.

We claim:

1. A method for managing a file processing workflow over multiple processing instances, the method comprising:
maintaining, by a computing system, a message queue for a cluster of processing instances, the cluster of processing instances comprising at least one producer-processing instance and at least one consumer-processing instance;
receiving, by the computing system from a producer-processing instance of the cluster, a notification message comprising a cluster identifier of the cluster associated with the producer-processing instance, and a data resource identifier associated with output data produced by the producer-processing instance in the file processing workflow;
forwarding, by the computing system, the notification message received from the producer-processing instance to the message queue for the cluster based on the cluster identifier; and
transmitting, by the computing system, the notification message from the message queue for the cluster to a consumer-processing instance of the cluster for processing the output data based on the data resource identifier.

2. The method as claimed in claim 1, wherein the cluster identifier is a cluster name, and wherein the data resource identifier is a uniform resource locator (URL) for the output data.

3. The method as claimed in claim 1, wherein the cluster is one of a plurality of clusters of processing instances in a multi-tier processing instance environment, and wherein the at least one producer-processing instance and the at least one consumer-processing instance of the cluster are at different tiers of the multi-tier processing instance environment.

4. The method as claimed in claim 1, wherein the transmitting the notification message to the consumer-processing instance of the cluster is based on receiving a job request message from the consumer-processing instance of the cluster.

5. The method as claimed in claim 1, comprising:
determining, by the computing system, a number of pending jobs for the cluster based on a number of notification messages pending in the message queue for the cluster; and
registering, by the computing system, in real-time, at least one new consumer-processing instance for the cluster when the number of pending jobs exceeds a pending jobs threshold value.

6. The method as claimed in claim 1, comprising:
determining, by the computing system, a job production throughput for the cluster based on a rate at which notification messages are forwarded in the message queue for the cluster;
determining, by the computing system, a job consumption throughput for the cluster based on a rate at which notification messages are consumed from the message queue for the cluster;
registering, by the computing system, in real-time, at least one new consumer-processing instance for the cluster when the job production throughput exceeds the job consumption throughput by a first threshold rate value; and
deregistering, by the computing system, in real-time, the at least one consumer-processing instance for the cluster when the job consumption throughput exceeds the job production throughput by a second threshold rate value.

7. The method as claimed in claim 1, comprising:
receiving, by the computing system, meta-data associated with the output data from the at least one producer-processing instance of the cluster; and
providing, by the computing system, the meta-data to an audit manager for auditing the file processing workflow.

8. A system for managing a file processing workflow over multiple processing instances, the system comprising:
a processor;
a message broker coupled to the processor to:
register at least one producer-processing instance and at least one consumer-processing instance in a cluster of processing instances;
maintain a message queue for the cluster of processing instances;
receive from a producer-processing instance of the cluster a notification message comprising a cluster identifier of the cluster associated with the producer-processing instance, and a data resource identifier associated with output data produced by the producer-processing instance in the file processing workflow; and
forward the notification message received from the producer-processing instance to the message queue for the cluster based on the cluster identifier; and
a job dispatcher coupled to the processor to transmit the notification message from the message queue for the cluster to a consumer-processing instance of the cluster for processing the output data based on the data resource identifier.

9. The system as claimed in claim 8, wherein the cluster identifier is a cluster name, and wherein the data resource identifier is a uniform resource locator (URL) for the output data.

10. The system as claimed in claim 8, comprising a job monitor coupled to the processor to determine a number of pending jobs for the cluster based on a number of notification messages pending in the message queue for the cluster, wherein the message broker is to register, in real-time, at least one new consumer-processing instance for the cluster when the number of pending jobs exceeds a pending jobs threshold value.

11. The system as claimed in claim 8, comprising a job monitor coupled to the processor to:
determine a job production throughput for the cluster based on a rate at which notification messages are forwarded in the message queue for the cluster;
determine a job consumption throughput for the cluster based on a rate at which notification messages are consumed from the message queue for the cluster; and
wherein the message broker is to register, in real-time, at least one new consumer-processing instance for the cluster when the job production throughput exceeds the job consumption throughput by a first threshold rate value.

12. The system as claimed in claim 8, comprising a job monitor coupled to the processor to:
determine a job production throughput for the cluster based on a rate at which notification messages are forwarded in the message queue for the cluster;
determine a job consumption throughput for the cluster based on a rate at which notification messages are consumed from the message queue for the cluster; and
wherein the message broker is to deregister, in real-time, the at least one consumer-processing instance for the cluster when the job consumption throughput exceeds the job production throughput by a second threshold rate value.

13. A non-transitory computer-readable medium comprising computer-readable instructions, which, when executed by a computer, cause the computer to:
receive from a producer-processing instance of a cluster of processing instances a notification message comprising a cluster identifier of the cluster associated with the producer-processing instance, and a data resource identifier associated with output data produced by the producer-processing instance in a file processing workflow;
forward, based on the cluster identifier, the notification message received from the producer-processing instance to a message queue for the cluster maintained in the computer; and
transmit the notification message from the message queue for the cluster to a consumer-processing instance of the cluster for processing the output data based on the data resource identifier.

14. The non-transitory computer-readable medium as claimed in claim 13, wherein the instructions which, when executed by the computer, cause the computer to:
determine a number of pending jobs for the cluster based on a number of notification messages pending in the message queue for the cluster; and
register, with the computer, in real-time, at least one new consumer-processing instance for the cluster when the number of pending jobs exceeds a pending jobs threshold value.

15. The non-transitory computer-readable medium as claimed in claim 13, wherein the instructions which, when executed by the computer, cause the computer to:
determine a job production throughput for the cluster based on a rate at which notification messages are forwarded in the message queue for the cluster;
determine a job consumption throughput for the cluster based on a rate at which notification messages are consumed from the message queue for the cluster;
register, with the computer, in real-time, at least one new consumer-processing instance for the cluster when the job production throughput exceeds the job consumption throughput by a first threshold rate value; and
deregister, from the computer, in real-time, the at least one consumer-processing instance for the cluster when the job consumption throughput exceeds the job production throughput by a second threshold rate value.
